(19) United States
(12) Patent Application Publication
(10) Pub. No.: US 2011/0293022 A1
(43) Pub. Date: Dec. 1, 2011

(54) MESSAGE PASSING INTERFACE (MPI) FRAMEWORK FOR INCREASING EXECUTION SPEEDAULT DETECTION USING EMBEDDED WATERMARKS

(75) Inventors: Rajan Laxman Joshi, San Diego, CA (US); Dong-Qing Zhang, Plainsboro, NJ (US); Anand Singh Bisen, Burbank, CA (US)

(73) Assignee: Thomson Licensing, Princeton, NJ (US)

(21) Appl. No.: 13/138,390

(22) PCT Filed: Feb. 27, 2009
(86) PCT No.: PCT/US2009/001276

§ 371 Date: Aug. 10, 2011

(51) Int. Cl. H04N 7/26; H04B 1/66; H04L 27/00

(52) U.S. Cl. 375/240.26; 375/259; 375/240; 375/E07.2

(57) ABSTRACT

A system and method for processing video uses a message protocol to communicate between computing units. An image request message is sent to an administrator process of a master node from at least one slave process to request an image to process. Responsive to the request message, an image name message is sent to a requesting slave process from the administrator process to retrieve the image from a queue. The image associated with the image name is processed. Images to process are requested until a completion message is received from the administrator process.

### TECHNICAL FIELD

The present invention generally relates to a multi-core processing framework and method, and more particularly, to systems and methods for increased execution speed using Message Passing Interface (MPI) technology.

### BACKGROUND

In digital cinema as well as in systems dealing with high definition video, the video resolution is typically 1920×1080 or higher, and frame rates are typically 24 frames per second or higher. Often, it is desired or required that all the processing be done in real-time or nearly so. In such cases, the processing requires a substantial amount of computing power. Recently, due to the advent of computer processing units (CPUs) with 2 or more cores, the computing power has increased substantially. Also, clusters of computers are now being constructed that have multiple multi-core CPUs. One such demanding application is JPEG2000 encoding and decoding. On a single CPU with multiple cores, one way of utilizing all the cores is to make the program multi-threaded. However, it is fairly common that multi-threading implementations are unable to utilize all the cores at 100% capacity. Furthermore, multi-threading, by itself, cannot run a program across multiple CPUs in a computing cluster.

### SUMMARY

A system and method for processing video includes providing a plurality of processing nodes including a master node and slave nodes communicating using a message protocol. An image request message is sent to an administrator process of the master node from at least one slave process to request an image to process. Responsive to the request message, an image name message is sent to a requesting slave process from the administrator process to retrieve the image from a queue. The image associated with the image name is processed. Images to process are requested until a completion message is received from the administrator process.

A system and method for processing video uses a message protocol to communicate between computing units. An image request message is sent to an administrator process of a master node from at least one slave process to request an image to process. Responsive to the request message, an image name message is sent to a requesting slave process from the administrator process to retrieve the image from a queue. The image associated with the image name is processed. Images to process are requested until a completion message is received from the administrator process.

A system for processing video includes a plurality of processing nodes including a master node and slave nodes, a message protocol interface configured to permit message communication between the master node and the slave nodes, a slave process disposed at a slave node and configured to generate an image request message requesting an image to process. An administrator process is disposed at the master node and configured to receive the image request message and, responsive to the request message, the administrator process sends an image name message to the slave process to retrieve the image from a queue. The slave process is configured to process the image associated with the image name and request additional images to process until a completion message is received from the administrator process.

### BRIEF DESCRIPTION OF THE DRAWINGS

The teachings of the present invention can be readily understood by considering the following detailed description in conjunction with the accompanying drawings, in which:

FIG. 1 is a block/flow diagram showing a system/method for compression of video frames to a desired file size in accordance with an aspect of the present principles;

FIG. 2 is a block/flow diagram showing a system/method for scheduled parallel processing using a Message Passing Interface (MPI) protocol; and

FIG. 3 is a block/flow diagram showing execution logic for slave and administrator processes in accordance with an aspect of the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION

The present principles provide systems and methods for employing a Message Passing Interface (MPI) framework to run encoding/decoding applications, such as, e.g., JPEG2000, seamlessly across multiple cores or a cluster of computers while utilizing each CPU resource to its fullest capacity. In one embodiment, an MPI framework is used across a cluster of computers to perform precise rate-control in a JPEG2000 encoder. The present principles are applicable to cases in which the processing of each video frame in a sequence is independent of other video frames. In such a case, one possibility is to use a grid engine such as, e.g., a Sun™ grid engine to handle scheduling of jobs to each core in the computing cluster, where a separate job is created for each frame to be processed. This approach may experience difficulty when it is necessary to exchange data at the end of processing and take further action.

CPUs with multiple cores can result in a dramatic increase in computational power. Clusters of computers with multiple multi-core CPUs may also be employed. It is desirable that each core in a CPU or cluster is utilized at nearly 100% capacity when running computationally intensive tasks. In accordance with the present principles, an MPI framework achieves seamless 100% capacity when running computationally intensive tasks regardless of whether only a single CPU with multiple cores or a computing cluster is employed. In this disclosure, we discuss the present principles in the context of performing precise rate-control in JPEG2000 encoding to demonstrate the present principles.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

In accordance with the present principles, each video frame can be processed independently of other frames in the sequence. One example of this is the compression of each frame using Joint Photographic Experts Group 2000 (JPEG2000) (see e.g., Information Technology—JPEG2000 Image Coding System—Part 1, ISO/IEC international Standard 15444-1 2003, ITU Recommendation T.800, 2002).

In many applications, there is a requirement that the overall file size of the compressed video (FS_{c}) is within a specified tolerance interval δ of a target file size (FSₜ). In JPEG2000 (Information Technology—JPEG2000 Image Coding System, ISO/IEC International Standard 15444-1, ITU Recommendation T.800) many different approaches are possible for achieving this goal. Some of these include the following:
1. Use a constant number of bits to compress each frame so that the target file size is almost exact.
2. Use external bit allocation based on human visual system, feature maps, complexity, etc., to allocate bits to different frames and to different areas within a frame so that the target file size is achieved with a specified tolerance.
3. Choose a quantization table to be used for compressing each frame; and then determine a scaling factor for the quantization table, such that the target file size is achieved within a specified tolerance. In the JPEG2000 context, the quantization table refers to the individual quantizer step-sizes used to quantize each subband.
4. Determine a rate-distortion slope parameter for discarding coding passes such that the target file size is achieved with a specified tolerance.

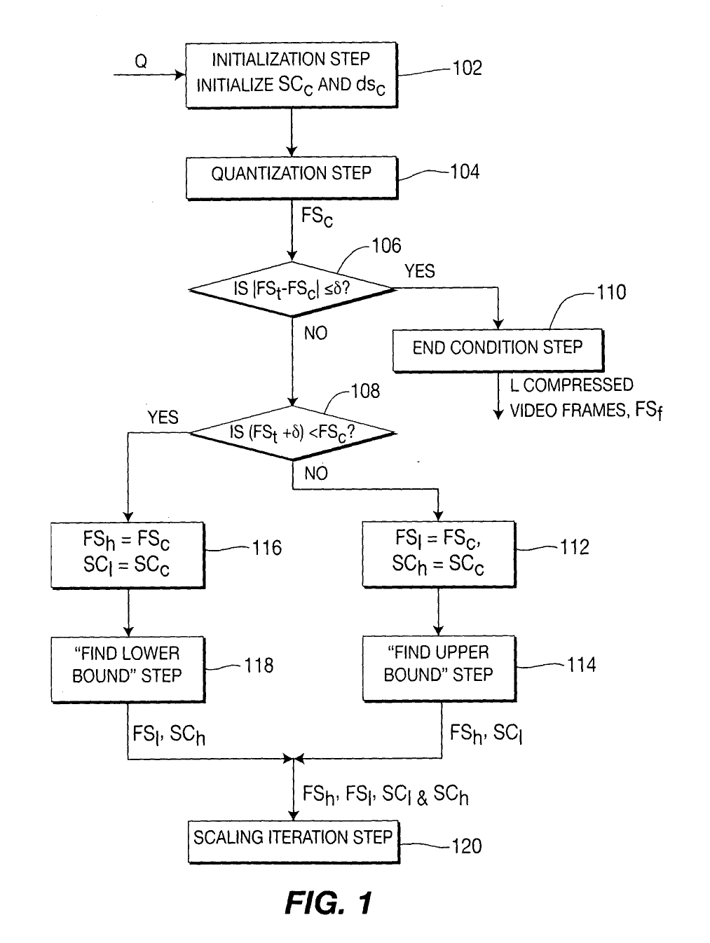

The method chosen depends on the specific application and requirements. The quantization table in approach 3 can be chosen based on the properties of the human visual system (HVS). We have determined that approach 3 results in roughly similar visual quality for different frames in the video sequence, and hence, is used in a preferred embodiment. When approach 3 is used, it is desirable to determine a scaling factor (SC) such that the overall compressed tile size is equal to the target file size within a specified tolerance. Each quantization table entry is multiplied by the scaling factor to derive the actual quantization table. Determining the exact scaling factor needed analytically is difficult as there is no direct relationship between the scaling factor and the compressed file size. A computationally efficient method to achieve this is described with respect to FIG. 1.

It is assumed that each frame is compressed independently using JPEG2000 or any other compression algorithm. Thus, the overall compressed file size refers to the sum of the compressed file sizes for individual frames. Those skilled in the art will recognize that it can be possible to concatenate individual compressed frames into a single compressed file for the entire video. This is especially true at the final iteration and any other instance when each frame from the video sequence is being compressed.

Referring now in specific detail to the drawings in which like reference numerals identify similar or identical elements throughout the several views, and initially to FIG. 1, an exemplary block/flow diagram shows a system/method for compressing video frames in accordance with one illustrative embodiment. Let the total number of video frames be L Let the target compressed file size be FSₜ and the file size tolerance be ±δ%. The values of FSₜ and δ are user-specified. In an initialization step in block 102, a quantization table (Q), current scaling factor (SC_{c}), and a current downsampling factor (ds_{c}) are selected. The quantization table Q can be chosen, e.g., based on a contrast sensitivity model of the human visual system (see e.g., Paul W. Jones, “Efficient JPEG 2000 VBR Compression with True Constant Perceived Quality,” SMPTE Journal, July/August 2007), but it can also be user-specified. A compression or quantization, in block 104, compresses up to L video frames using the quantization table Q, scaled by the scaling factor SC_{c}. Let the overall compressed file size after this step be FS_{c}.

If FS_{c} is within the tolerance limit, that is, if |FSₜ−FS_{c}|≦δ in block 106, an end condition step is executed in block 110. In block 110, every video frame that was not compressed in the previous compression step is compressed using the quantization table Q, scaled by the scaling factor SC_{c} and the process is stopped. The resulting final overall compressed file size is FS_{f}. Otherwise in block 108, if FSₜ+δ<FS_{c}, FSₕ is set to FS_{c} and SCₜ is set to SC_{c} in block 116. Then, values of FSₜ and SCₕ are found in the “find lower bound” step in block 118. Recognize that lower values of SC correspond to less aggressive quantization and hence higher compressed file sizes. Otherwise, in block 108, if (FSₜ−δ)>FS_{c}, FSₜ is set FS_{c} and SCₕ is set to SC_{c} in block 112. Then, values of FSₕ and SCₗ are found in the “find upper bound” step in block 114. The values, FSₗ, FSₕ, SCₗ and SCₕ are input to a “scaling factor iteration” step in block 120.

The “scaling factor iteration” provides that SC_{c} is updated using linear interpolation, although other interpolation methods are possible based on the modeling of the dependence of overall compressed file size on the scaling factor. In a preferred embodiment, SC_{c} is updated as:

$${SC}_{c} = {SC}_{l} + \frac{( {SC}_{h} - {SC}_{l} )}{( {FS}_{h} - {FS}_{l} )} ( {FS}_{t} - {FS}_{l} ) .$$

A new value for downsampling factor ds_{c} is also set based on the ratio (FSₕ−FSₗ)/FSₜ, only if it leads to a lower downsampling factor. Then, the quantization table Q, and the updated parameters scaling factor SC_{c}, and downsampling factor ds_{c} are input to the compression step 104. The compression step 104 outputs a new estimated compressed file size FS_{c}. If FS_{c} is within the tolerance limit, the flow control passes to the “end condition” step 110. If FS_{c}<FSₜ, FSₗ is set to FS_{c} and SCₕ is set to SC_{c}. Otherwise, if FS_{c}>FSₜ, FSₕ is set to FS_{c} and SCₗ is set to SC_{c}. Then, the flow control is returned to the beginning of the “scaling factor iteration” step 120. In rare cases, FS_{c} can fall outside the interval [FSₗ,FSₕ] resulting in a widening of the interval after the update. This can happen only when the downsampling factor has been updated. In practice, if this condition occurs, it gets corrected quickly in the subsequent scaling factor iterations.

Now, we will describe the compression step 106 in greater detail. The input to the quantization step are L video frames, ds_{c}, Q, SC_{c}. Let the remainder after dividing L by ds_{c} be r. Then, an offset is chosen at random such that 0≦offset<r 0 [offset<r. Let the video frames be indexed from 0 to L−1. Then, the number of frames that are compressed in the compression step is calculated as

$${L}_{c} = ⌊ \frac{L - offset - 1}{{ds}_{c}} ⌋ + 1.$$

The indices of the frames that are compressed are given by n×ds_{c}+offset, where 0≦n<L_{c}. Each such frame is compressed using quantization table Q scaled by SC_{c}. Let the sum of the file sizes of the compressed frames be FS_{ds}. Then, the overall compressed file size is estimated to be FS_{c}=FS_{ds}×(L/L_{c}). Instead of choosing the offset at random, it is possible to choose a fixed value such as 0.

To find the lower bound step in block 118, FSₕ and SCₗ are already set and we are trying to find FSₗ and the corresponding SCₕ such that FSₗ<FSₜ. First, scaling factor SC_{c} is initialized to SCₗ and a multiplication factor MEₗ is chosen. This is greater than 1.0 and can be user-specified or a function of (FSₕ−FSₜ)/FSₜ. In a preferred embodiment, we use a multiplication factor of 1.5. Then SC_{c} is set to SC_{c}×MFₗ. Compression is performed using the compression step 104 with quantization table Q, scaling factor SC_{c}, and downsampling factor ds_{c} to produce an estimate FS_{c} for the overall compressed file size. If FS_{c} is within the tolerance limit, the flow control passes to the “end condition” step in block 110. Otherwise, if FS_{c}>FSₜ, flow control is returned to the beginning of the “find lower bound” step 118. Otherwise, FSₗ is set to FS_{c} and SCₕ is set to SC_{c} and the flow control is passed to the “scaling factor iteration” step 120 with parameters FSₗ, FSₕ, SCₗ and SCₕ.

For the find upper bound step in block 114, FSₗ and SCₕ are already set and we are trying to find FSₕ and the corresponding SCₗ such that FSₗ<FSₕ. First, the scaling factor SC_{c} is initialized to SCₕ and a division factor DFₕ is chosen. This is between 0 and 1 and can be user-specified or a function of (FSₜ−FSₗ)/FSₜ. In a preferred embodiment, we use a division factor of 1/1.5. Then, SC_{c} is set to SC_{c}/DFₕ. Compression is performed using the compression step with quantization table Q, scaling factor SC_{c}, and downsampling factor ds_{c} to produce an estimate FS_{c} for the overall compressed file size. If FS_{c} is within the tolerance limit, the flow control passes to the “end condition” step in block 110. Otherwise, if FSₜ>FS_{c}, flow control is returned to the beginning of the “find upper bound” step in block 114. Otherwise, FSₕ is set to FS_{c} and SCₗ is set to SC_{c} and the flow control is passed to the “scaling factor iteration” step in block 120 with parameters FSₗ, FSₕ, SCₗ and SCₕ.

It should be noted that the flow control can terminate only through the “end condition” step in block 110. Also, it is not guaranteed that the final compressed file size is within the tolerance interval. This is because the stop decision can be arrived at based on a downsampling factor that is greater than 1, whereas the final compression step compresses all the frames (ds=1). If ds=1 and offset=0 is used as the initial value, then the downsampling factor remains constant throughout. In that case, the method is much simplified and is guaranteed to produce an overall compressed file size within the tolerance limits of the target file size.

In JPEG2000, it is common to use a rate-distortion parameter to determine the compressed coding pass data that is included in the final code-stream. In that case, instead of finding a scaling factor that achieves the target compressed file size, we are trying to find a rate-distortion slope parameter that produces the target compressed file size. Those skilled in the art will realize that instead of iterating on the scaling factor, it would be possible to iterate on the rate-distortion slope parameter to achieve the overall target compressed file size.

It is possible to apply this method to the rate-control of AVC H.264 intra-only bit-streams (ISO/IEC 14496-10:2003, “Coding of Audiovisual Objects—Part 10: Advanced Video Coding,” 2003, also ITU-T Recommendation H.264 “Advanced video coding for generic audiovisual services”). Some profiles in H.264 offer an option to use custom Q-tables. Additionally, AVC H.264 offers the flexibility of choosing a quantization parameter QP that can be varied from one macroblock to another. However, it can be desirable to maintain a constant value of QP throughout the video. In such a case, those skilled in the art will recognize that the present method can be applied for performing rate-control. This scenario is more restrictive, since QP can take only integer values.

We assume that each frame is compressed independently to provide a compressed frame. The quantization parameters can be different for different frames, but in a preferred embodiment, all the frames are compressed with a fixed quantization table Q and scaling factor SC_{c}. A scaling factor SC_{c} needs to be determined that will achieve a target file size for the compressed video frames. The quantization step performed in block 104 outputs a compressed version. In accordance with the present principles, a rate-control method as described above can be performed in a way that balances the execution of the computational load across a plurality of processing cores.

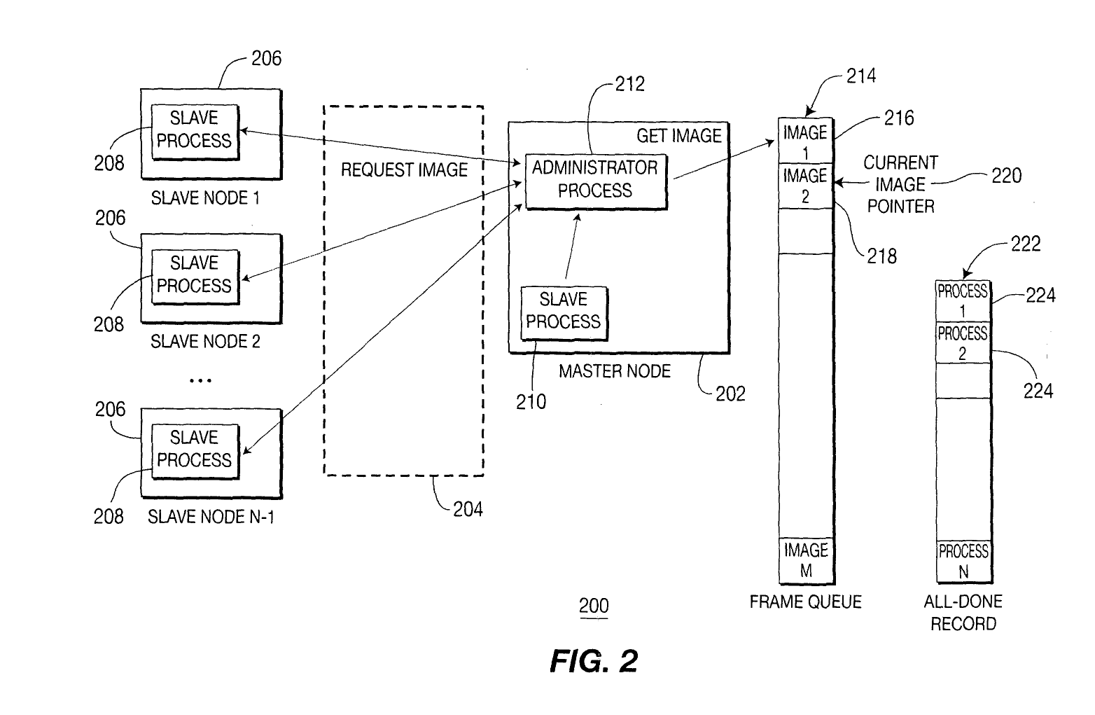

Referring to FIG. 2, a system/method 200 using a Message Passing Interface (MPI) 204 is preferably employed to implement processes, e.g., the rate-control method of FIG. 1, on a computer cluster including one or more CPUs, each CPU having one or more cores. The system/method provides for scheduled parallel processing of slave nodes using MPI to coordinates processing efforts. We assume that the cores in the computing cluster can access a common file system. It is not necessary that they share memory (RAM). One of the cores is a master node 202 and the remaining cores are slave nodes 206. In MPI 204, the master node 202 runs two sub-processes, an administrator process 212 and a slave process 210. Each slave node 206 runs a single slave process 208. In one embodiment, the slave processes 208 compress the frames and send back the data to the administrator process 212. The administrator process 212 is responsible for scheduling of tasks, communication with the slave processes 208, and overall execution logic. The communication between the administrator process 212 and slave processes 108 are realized by a communication protocol 204, for example Message Passing Interface (MPI) for a high performance computing environment.

Referring to FIGS. 1 and 2, in one embodiment, all the steps except the “quantization” step 104 and the “end condition” step 110 are preferably executed by the administrator process 212. The “quantization” 104 and “end condition” 110 steps are executed by the master 202 and the slaves 206. Let the total number of video frames be L. In each of the steps of FIG. 1, compress M frames, where M≦L. Let the number of slave processes 208 be N. For compressing a frame, quantization parameters and the name of the file in which the video frame is stored need to be communicated to the slave node 206. In a preferred embodiment, the quantization table Q remains constant throughout the process. So, it suffices to broadcast the quantization table Q once to all the slave nodes 206. Whenever the administrator process 212 receives a request from a slave process 208 for a frame to compress, it communicates only a scale factor SC, and the file name of the video frame to be compressed to the slave process 208. After the requested frame has been compressed, the slave process 208 communicates the size of the compressed frame to the administrator process 212.

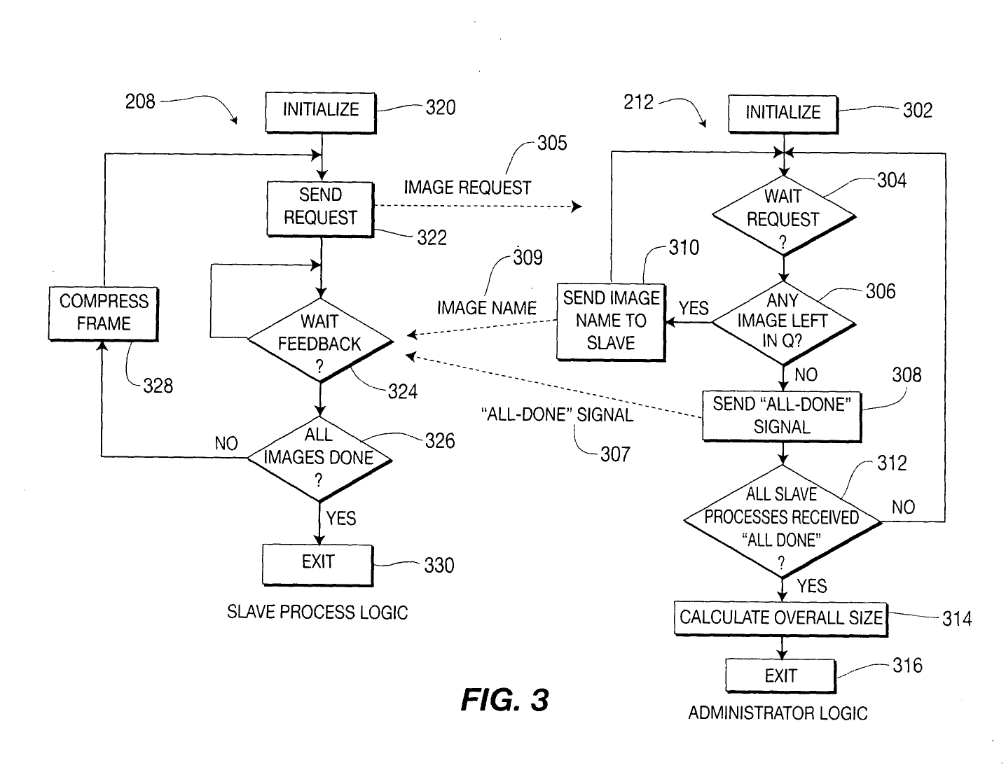

Referring to FIG. 3, with continued reference to FIG. 2, steps executed by the administrator process 212 in compressing M frames using the MPI protocol 204 are illustratively shown. During initialization in block 302, the administrator process 212 receives a list of M frames, a quantization table Q and a scale factor SC. The administrator process 212 broadcasts the quantization table Q to all the slave processes 208. Then, the administrator process 212 waits to receive a request 305 from a slave process 208 in block 304. When a request is received, the administrator process 212 checks whether any more frames need to be compressed in block 306. If not, the administrator process 212 sends an “All-done” signal or completion signal 307 in block 308 to that slave process 208. Otherwise, the administrator process 212 sends a current frame name and scale factor 309 in block 310 to the slave process 208 and goes back to wait for a new request in block 304.

The administrator process 212 maintains a queue of image frame names 214 (FIG. 2). Whenever the administrator process 212 sends a frame name (216) to the slave process 208, a queue pointer 220 moves to a next frame name (218). The administrator process 212 also maintains a record 222 of the slave processes 224 that have been sent the “All-done” signal 307. Now, the administrator process 212 checks whether the “All-done” signal 307 has been sent to all the slave processes 208 in block 312. If this is not the case, the administrator process 212 goes back to the start of the waiting loop 304 and waits for a new request. Otherwise, the administrator process 212 calculates the cumulative compressed file size for all the frames compressed by the slave processes and estimates the overall compressed file size by multiplying the cumulative compressed file size by a factor of (L/M) in block 314. The program exits in block 316.

Now, the steps carried out by each slave process 208 will be described. After an initialization of the slave process 208 in block 320, the slave process 208 sends a request 305 for a frame to be compressed in block 322. Then, the slave process 208 goes into a waiting loop in block 324 until the slave process 208 receives a response from the administrator process 212. If the response is “All-done” 307 in block 326, the slave process exits in block 330. If the response is the name of a frame 309, the slave process 208 compresses the frame with the provided scaling factor in block 328. Then, the slave process 208 goes back and sends another request to the administrator process in block 322. The present principles have been described in the context of compression. However, those skilled in the art will recognize that the principles are applicable to any processing that can be performed independently on each frame.

Advantageously, in accordance with the present principles, compression, encoding, decoding or any other processing step or steps can be distributed for execution among a plurality of slave nodes or slave processes. The slave nodes and a master node advantageously communicate using a messaging protocol. The slave nodes/processes are preferably on different processing cores or employ different CPUs and inform the master node when they are ready to receive more job tasks. This provides a more efficient use of available resources and promotes 100% utilization of processing cores.

Having described preferred embodiments for systems and methods for message passing interface (MPI) framework for increasing execution speed for encoding and decoding (which are intended to be illustrative and not limiting), it is noted that modifications and variations can be made by persons skilled in the art in light of the above teachings. It is therefore to be understood that changes can be made in the particular embodiments of the invention disclosed which are within the scope and spirit of the invention as outlined by the appended claims. While the forgoing is directed to various embodiments of the present invention, other and further embodiments of the invention can be devised without departing from the basic scope thereof.

1. A method, comprising:
sending an image request message to a master node from at least one slave node to request an image;
responsive to the request message, sending an image name message to a requesting slave node;
processing the image associated with the image name; and
requesting images to process until receipt of a completion message.

2. The method as recited in claim 1, further comprising the step of:
utilizing master node and slave nodes on cores of a computer processor.

3. The method as recited in claim 1, further comprising the steps of:
compressing image files of the images; and
computing a cumulative compressed file size for the image files compressed by the slave nodes.

4. The method as recited in claim 3, further comprising the step of:
estimating an overall compressed file size by multiplying the cumulative compressed file size by a factor.

5. The method as recited in claim 3, further comprising the step of:
determining whether a compressed file size meets a target file size within an acceptable tolerance range.

6. The method as recited in claim 1, further comprising the step of:
maintaining a record of the slave nodes that have been sent a completion message.

7. The method as recited in claim 1, further comprising the steps of:
initializing an administrator process by receiving a list of frames, a quantization table and a scale factor;
broadcasting the quantization table to slave processes on the slave nodes; and
waiting to receive an image request message from a slave process on a slave node.

8. The method as recited in claim 1, further comprising the step of:
utilizing processing that includes Joint Photographic Experts Group 2000 encoding.

9. A method for compressing video frames in a processing system having a plurality of processing cores:
providing a message program interface to effect communications between a master node and at least one slave node;
sending an image request message to a master node from at least one slave node to request an image to process;
responsive to the request message, sending an image name message to a requesting slave node to retrieve the image from a queue;
compressing the image associated with the image name;
requesting images to process until a completion message is received; and
estimating an overall compressed file size to provide a final file size.

10. The method as recited in claim 9, further comprising the step of:
determining whether a compressed file size meets a target file size within an acceptable tolerance range.

11. The method as recited in claim 9, further comprising the step of
maintaining a record of slave processes on the slave nodes that have been sent a completion message.

12. The method as recited in claim 9, further comprising the steps of:
initializing an administrator process by receiving a list of frames, a quantization table and a scale factor;
broadcasting the quantization table to slave processes on the slave nodes; and
waiting to receive an image request message from a slave process on a slave node.

13. The method as recited in claim 9, further comprising the step of:
utilizing processing that includes Joint Photographic Experts Group 2000 encoding.

14. A system for processing video, comprising:
a plurality of processing nodes including a master node and at least one slave node;
a message protocol interface configured to permit message communication between the master node and the at least one slave node, the slave node performing at least one slave process to generate an image request message; and
the master node performing at least one administrator process to receive the image request message and sends an image name message to the slave node;
the slave node configured to process the image associated with the image name and requesting additional images to process until receipt of a completion message.

15. The system as recited in claim 14, wherein the plurality of processing nodes are each included on a processing core of a computer processor.

16. The system as recited in claim 14, wherein the slave node compresses image files of the images and the administrator process computes a cumulative compressed file size for all the image files compressed by processes run by slave nodes.

17. The system as recited in claim 16, wherein the administrator process estimates an overall compressed file size by multiplying the cumulative compressed file size by a factor.

18. The system as recited in claim 16, wherein the slave node determines whether a compressed file size meets a target file size within an acceptable tolerance range.

19. The system as recited in claim 14, further comprising a record of slave processes that have been sent the completion message.

20. The system as recited in claim 14, wherein the processing includes Joint Photographic Experts Group 2000 encoding.
